(19) United States
(12) Patent Application Publication
(10) Pub. No.: US 2015/0313187 A1
(43) Pub. Date: Nov. 5, 2015

(54) Collection Device

(71) Applicants: Marvin Seller, New York, NY (US); Gary Blum, Nanuet, NY (US)

(72) Inventors: Marvin Seller, New York, NY (US); Gary Blum, Nanuet, NY (US)

(21) Appl. No.: 14/702,389

(22) Filed: May 1, 2015

Related U.S. Application Data
(60) Provisional application No. 61/987,405, filed on May 1, 2014.

(51) Int. Cl. A01K 23/00

(52) U.S. Cl. CPC A01K 23/005

(57) ABSTRACT

An improved collection device for handling pet waste, removing the need for a pet handler/user to come into contact with the pet waste. The device has an elongated handle, a thin frame forming a void at the end of the handle, and a bag removably attached to the frame, the body of the bag resting in the void. The bag has a drawstring closure. The bag has an extended exterior flap allowing for secure placement on the frame.

### FIELD OF INVENTION

The present invention is in the field of pet waste removal and control.

### BACKGROUND

Today, most public areas require, usually by statute, dog owners to dispose of their pet's droppings in a sanitary manner. The most common methods existing today are either cumbersome and unsanitary “scoop and drop” devices, or unsavory manual pick up by hand utilizing plastic bag.

The unique catch, close and drop device has been developed specifically to allow dog owners or handlers to completely avoid the need to either scoop up droppings, or to pick up droppings by hand, thereby making the exercise a more efficient, more sanitary, and less unpleasant experience.

Existing devices and methods for removal of pet waste involve the pet handler to wait for their pet to deposit excrement on the ground, and then the pet handler picks up the excrement, often using a plastic bag or protective glove. Such methods are inefficient, leaving waste particles on the ground or other surface, as well as requiring the pet handler to grasp waste with their hand, albeit through a bag or glove.

### SUMMARY OF THE INVENTION

The present invention provides an improved collection device for handling pet waste, removing the need for a pet handler/user to come into contact with the pet waste. The device has an elongated handle, a thin frame forming a hoop at the end of the handle, and a drawstring bag removably attached to the frame. The drawstring bag has an extended exterior flap allowing for secure placement on the frame. The device is designed for the pet handler/user to place the frame and bag behind the pet while the pet is in the process of excreting, allowing the waste to enter the bag. The pet handler/user may then pull the draw string to close the bag and may dispose of the waste filled bag without touching the body of the bag.

### BRIEF DESCRIPTION OF THE DRAWINGS

FIG. 1 is a side view of the bag of the invention.

FIG. 2 is a top elevation view of the bag of the invention.

FIG. 3 is a perspective view of the invention, showing the bag attached to the frame.

FIG. 4 is a top elevation view of the invention, showing the bag attached to the frame.

FIG. 5 is top elevation view of the handle and frame of the invention.

FIG. 6 is a side view of the handle and frame of the invention.

FIG. 7 is a front view of the frame along line 7-7 of FIG. 6.

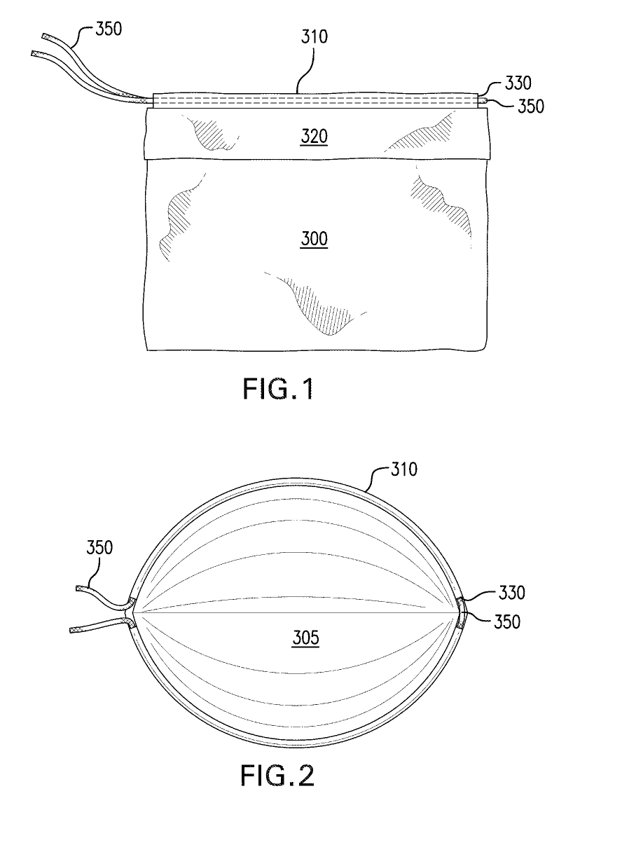

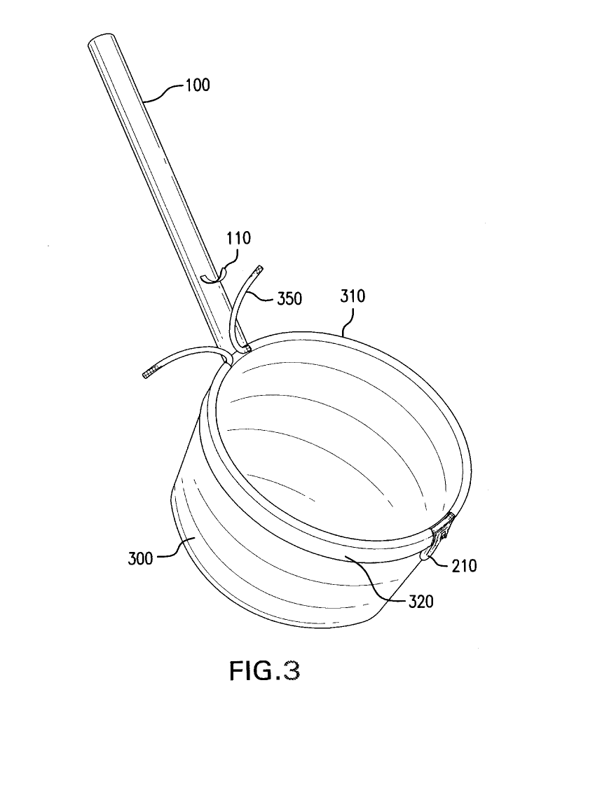

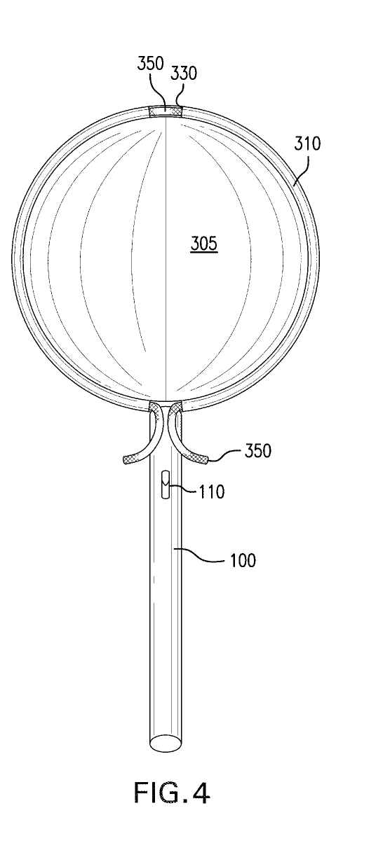

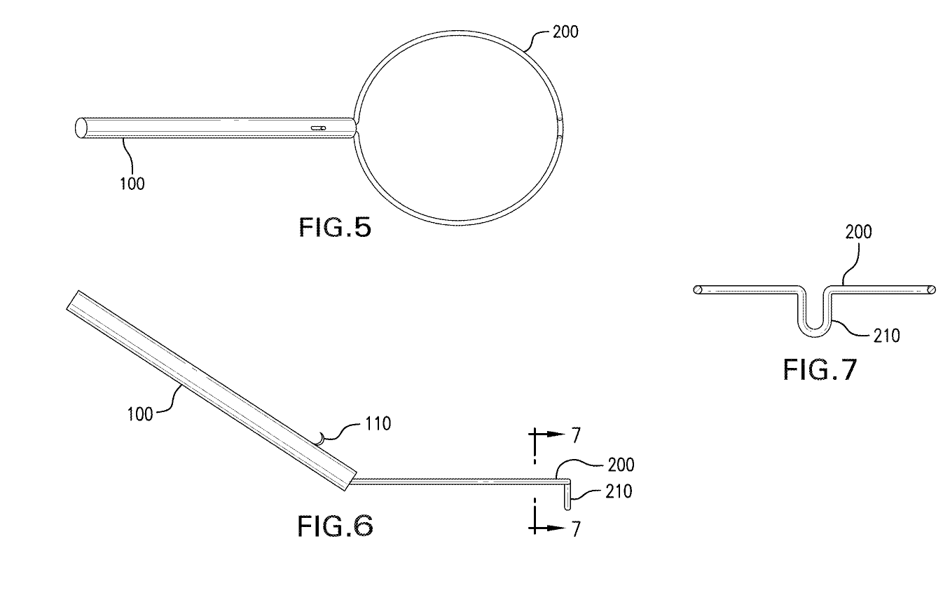

### DETAILED DESCRIPTION OF THE PREFERRED EMBODIMENT

The invention preferably consists of a frame 200 attached to an elongated handle 100. A bag 300 with a drawstring closure is removably placed on the rigid frame 200.

The elongated handle 100 has a distal end and a gripping end opposite the distal end. Handle 100 preferably has a hook 110 attached along a side of the handle, toward the distal end, where hook 110 provides a means to allow the drawstring 350 to be removably attached thereto.

The frame 200 is preferably formed of a thin elongated member, with both ends of the elongated member connected at the distal end of the elongated handle. The frame may form any number of shapes, with circular, elliptical, and diamond shapes being preferred. Frame 200 may be of a variety of sizes and made of any rigid or semi-rigid material. The size of frame 200 may vary to accommodate different uses. While the drawings show frame 200 as a circular hoop, one skilled in the art can see that alternate shapes would provide the same function.

The bag 300 is formed of two side panels connected at their bottom and sides, forming a bag opening at the top and surrounding a bag interior 305. The bag opening is approximately the size of the frame, with a channel 310 extending along the bag opening, allowing an elongated closure string 350 to pass therein. Preferably, bag 300 is comprised of plastic or other liquid impermeable material. In a preferred embodiment, bag 300 formed of two rectangular pieces of plastic, sealed at three of the four sides of the rectangles, with channel 310 surrounding the open sides.

A flap 320 is connected to the bag 300 at the opening, extending parallel to the sides of the bag. Preferably, the flap extends along the length of the bag opening, and the width of the flap is at least ½ inch from the bag opening. A wider flap aids in securing bag 300 on the frame. In a preferred embodiment, at least one edge of the flap is attached to an edge of a side panel of the bag, forming a pocket between the side panel and the flap. Flap 320 may be comprised of two separate flaps, one on each side of bag 300.

A distinctive feature of the invention is the positioning of the flap 320 relative to the opening of bag 300. Prior art string bags have cords or string sealed at a channel at the opening of the bag, but such bags cannot work for the purposes of the invention. Flap 320 allows the bag to sit on frame 200 without falling off, and positions channel 310 and closure string 350 atop frame 200 for easy removal with a pull of the string.

As an optional feature, removable securing means can be applied to flap 320, allowing flap 320 to be removably attached to the side of bag 300. Examples of such removable securing means include adhesive strips, snaps, fasteners or similar means as are known in the art.

The elongated closure string 350 of the flexible bag 300 preferably extends through a channel 310 adjacent to the opening of the bag 300, with the ends of the closure string 350 extending outward from an opening in channel 310 near handle 100. Channel 310 may have two openings proximate to each other, or may have open gaps along the periphery of the bag opening. In a preferred embodiment, channel 310 is open near handle 100 and also include a gap 330 opposite from handle 100.

At the opposite side of the frame 200 from the connection to the elongated handle 100, a U-shaped extension 210 is preferably formed. Extension 210 engages an edge of bag 300 to help secure bag 300 on frame 200, and prevent lateral rotation of bag 300. For additional support of bag 300, a loop of closure string 350 may be extended to engage extension 210. Doing so would prevent closure string 350 from being fully retracted, but on windy days, a pet handler/user might want the additional support to keep the bag from blowing off of frame 200.

A description of the operation of the invention is provided in the following paragraphs.

Prior to taking the pet for a walk, the pet handler/user places the bag 300 in the center of the frame 200 with the flap 320 placed over the perimeter of frame 200. The ends of closure string 350 may be tied together or otherwise placed over hook 110. Preferably the invention is made of lightweight materials so that the pet handler/user can hold the invention in one hand, possibly the same hand as used to hold a pet leash.

Upon noticing that the pet is preparing to defecate, the pet handler/user extends the invention such that frame 200 and bag 300 are directly under the pet's posterior, so that the feces are deposited directly into bag interior 305, instead of on the ground. After the pet has finished defecation, the pet handler/user moves entire device away from the pet.

The pet handler/user pulls on the ends of closure string 350 to close the bag 300. This action also serves to remove bag 300 from frame 200. The bag 300 may now be safely and sanitarily released and deposited into a convenient receptacle.

A key advantage of the present invention over prior art approaches is that due to the use of a removable bag, the present invention provides a more hygienic solution. Unlike prior art “scooper” devices, the main body of the invention does not come into contact with feces, and therefore will not need antiseptic cleaning. Further, unlike other bag-based solutions, the user of the present invention will not need to grasp the feces through the bag, a discomforting feeling, even if no actual contact is made. A user of the present invention will only need to grasp the ends of closure string 350 to pull bag 300 closed, and can then deposit bag 300 into a waste receptacle, all without the discomfort of being in contact with feces, even through a bag.

As an optional feature of the invention, hook 110 may be moveable along the side of elongated handle 100, providing a remote mechanism to pull closure string 350, thereby closing bag 300, and disengaging bag 300 from frame 200. After the bag has been filled, the pet handler/user may place the closed bag over a waste receptacle and remove closure string 350 off of hook 110, thereby allowing bag 300 to fall into the waste receptacle.

The invention can be used for more than collecting animal waste. Other uses include collecting fish from an aquarium tank; or catching insects, birds, or rodents. For certain applications, bag 300 could be made of a net or mesh material.

The invention may also include a telescoping or extension feature to handle 100, to allow for more flexibility in the size and ease of storage.

An alternate embodiment of the invention would provide a short handle 100, with an adapter that allows a user to use their own elongated support for the frame.

Closure string 350 may be a cord of any commonly known materials, such as twine, nylon, cotton string, rubber, wire or other similar materials.

While certain novel features of the present invention have been shown and described, it will be understood that various omissions, substitutions and changes in the forms and details of the device illustrated and in its operation can be made by those skilled in the art without departing from the spirit of the invention.

We claim:

1. A collection device comprising:
an elongated handle with a distal end;
a frame attached to the distal end of the elongated handle, the frame surrounding a void and forming a plane; and
a bag removably attached to the frame, the bag comprising two side panels, each side panel having a flat
attached at their peripheries, with an opening formed by an unattached edge of the sides, a channel formed along the opening, allowing an elongated flexible closure to extend through the channel,
where the bag is placed within the void of the frame, with the channel and opening of the bag adjacent to the frame.

2. The collection device of claim 1, further comprising:
a U-shaped bend in the frame, located opposite from the distal end of the elongated handle, the U-shaped bend oriented at an angle with respect to the plane formed by the frame.

3. The collection device of claim 1, the bag further comprising:
a flap extending along the channel and extending parallel to the side panels.

4. The collection device of claim 3, where the flap extends at least ½ inch from the channel.
